(19) United States
(12) Patent Application Publication
(10) Pub. No.: US 2009/0104988 A1
(43) Pub. Date: Apr. 23, 2009

(54) THREE-DIMENSIONAL GAME PIECE

(76) Inventors: Amy D. Enge, Spencerport, NY (US); James E. Adams, JR., Rochester, NY (US)

Correspondence Address: Frank Pincelli;Patent Legal Staff, Eastman Kodak Company, 343 State Street, Rochester, NY, 14650-2201, US

(21) Appl. No.: 11/876,795

(22) Filed: Oct. 23, 2007

(51) Int. Cl. A63F 13/00

(52) U.S. Cl. 463/31

(57) ABSTRACT

Moveable display units providing a gaming experience, each display unit includes one or more displays that when actuated change a visual image associated with the display. There is an operator interface including a computer and a first transceiver for sending and receiving signals from the moveable display units. Each moveable display unit includes a second transceiver and an associated sensor for detecting a marker indicating the position of the display unit and for providing a signal to the first transceiver, which communicates with the computer. The computer responds to the signal to cause the first transceiver to send a signal to the second transceiver on the moveable display unit to actuate a change in the visual image associated with such moveable display unit.

### FIELD OF THE INVENTION

This invention generally relates to display devices and more particularly relates to portable display devices having sensing and communication capabilities for interaction within a mixed reality environment.

### BACKGROUND OF THE INVENTION

Computer games of various types provide one or more displays to provide visualization of environments, characters, or various types of objects useful for imaginative play. For most games of this type, one or more participants view a display monitor that shows some portion of the game environment. Interaction with the game itself is typically through some type of cursor manipulation device, such as a mouse, keyboard, joystick, or other manipulable apparatus.

Many types of games that were conventionally played around a table or other playing surface have been adapted for computer play. For example, poker and other card games are now available for play using a computer display. The participant now sees the game using a display screen that shows those portions of the game that would be available for viewing by each player. This arrangement advantageously enables game play for people who are located at a considerable distance from each other. However, the use of a display screen introduces a level of abstraction that can take away from some enjoyment of game play. For example, tactile interaction and depth-perception are no longer possible where a display monitor serves as the virtual game board. A mouse click or drop and drag operation can be a poor substitute for the feel of handling a card or other game piece and placing it at a location on a playing surface. Few checker players would deny that part of the enjoyment for anyone who has ever enjoyed the game relates to the sound and tactile feel of jumping one's opponent. Executing this same operation on a display screen is bland by comparison.

Recognizing that tactile and spatial aspects of game play can add a measure of enjoyment, some game developers have proposed both display and manipulation devices that provide these added dimensions in some way. As one example, U.S. Pat. No. 7,017,905 entitled “Electronic Die” to Lindsey describes dice that incorporate sensing electronics and blinking light-emitting diode (LED) indicators, also providing some sound effects.

Other solutions have targeted more interactive ways to manipulate objects that appear on a display monitor. For example, U.S. Patent Application Publication No. 2005/0285878 entitled “Mobile Platform” by Singh et al. describes a mixed-reality three-dimensional electronic device that manipulates, on a separate display screen, the position of a multimedia character or other representation, shown against a video capture background that had been captured previously. This apparatus is described, for example, for selecting and adjusting furniture location in a virtual display.

Still other solutions have been directed to enhancing hand-held controls. For example, U.S. Patent Application Publication 2007/0066394 entitled “Video Game System with Wireless Modular Handheld Controller” by Ikeda et al. describes a handheld control mechanism for a computer game. The controller described in the Ikeda et al. '6394 disclosure has motion detectors and uses infrared-sensitive image sensors. An additional infrared emitter on the game itself projects an illumination pattern that can be detected by the controller sensors. Controller logic detects changes in the illumination pattern over time in order to detect and estimate relative movement of the controller and to provide a corresponding control signal.

Although solutions such as these provide some added dimension to game-playing, augmented reality, and related applications, there is room for improvement. Existing solutions such as those cited, employ movable devices for enhancing control capabilities, improving somewhat upon the conventional constraints associated with mouse and joystick devices. However, in spite of their increased mobility, solutions such as those proposed in the Singh et al. '8078 and Ikeda et al. '6394 disclosures are still pointer devices for a separate display, such as a conventional computer monitor screen or portable display device. Operator interaction with a game or virtual reality experience is limited to a display monitor paradigm for limited operator interaction, affecting some corresponding cursor movement and screen object controls.

### SUMMARY OF THE INVENTION

It is an object of the present invention to address the need for enhanced game-playing and simulation applications. With this object in mind, the present invention provides an apparatus for providing a gaming experience comprising

a. a plurality of moveable display units each of which includes one or more displays that when actuated change a visual image associated with the display,

b. an operator interface including a computer and a first transceiver for sending and receiving signals from the moveable display units,

c. each moveable display unit including a second transceiver and an associated sensor for detecting a marker indicating the position of the display unit and for providing a signal to the first transceiver which communicates with the computer; and

d. the computer responds to the signal to cause the first transceiver to send a signal to the second transceiver on the moveable display unit to actuate a change in the visual image associated with such moveable display unit.

It is a feature of the present invention that it has one or more variable display elements that can be placed at various positions for gaming, simulation, or other applications.

It is an advantage of the present invention, that it provides a display unit with a display that can be changed according to the status of a playing piece or other represented object.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

Although the specification concludes with claims particularly pointing out and distinctly claiming the subject matter of the present invention, it is believed that the invention will be better understood from the following description when taken in conjunction with the accompanying drawings, wherein:

FIG. 1 is a block diagram of a game apparatus according to an embodiment of the present invention;

FIG. 2 is a schematic block diagram showing internal components of a display unit in embodiments of the present invention;

FIG. 3 is a perspective view showing a display unit with multiple displays;

FIG. 4 is a perspective bottom view of a display unit;

FIG. 5 is a perspective bottom view of a display unit with cover removed;

FIGS. 6A and 6B are perspective views of display units on a game playing surface;

FIG. 7A is a perspective view of a portion of a game apparatus in which the playing surface is also a display;

FIG. 7B is a perspective view of a portion of a game apparatus in which the playing surface is also a display with a different embodiment;

FIG. 8 is a logic flow diagram showing a sequence of steps for display unit initialization and operation in one embodiment;

FIG. 9 is a perspective view of an arrangement in which multiple display units form a tiled display;

FIG. 10 is a perspective view showing the arrangement of FIG. 9 with one display unit removed;

FIG. 11 is a perspective view of an arrangement in which layers of multiple display units form a tiled display;

FIG. 12 is a perspective view showing an embodiment using display units at different spatial locations and orientations;

FIG. 13 is a perspective view showing position sensing for display units using a number of reference points.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

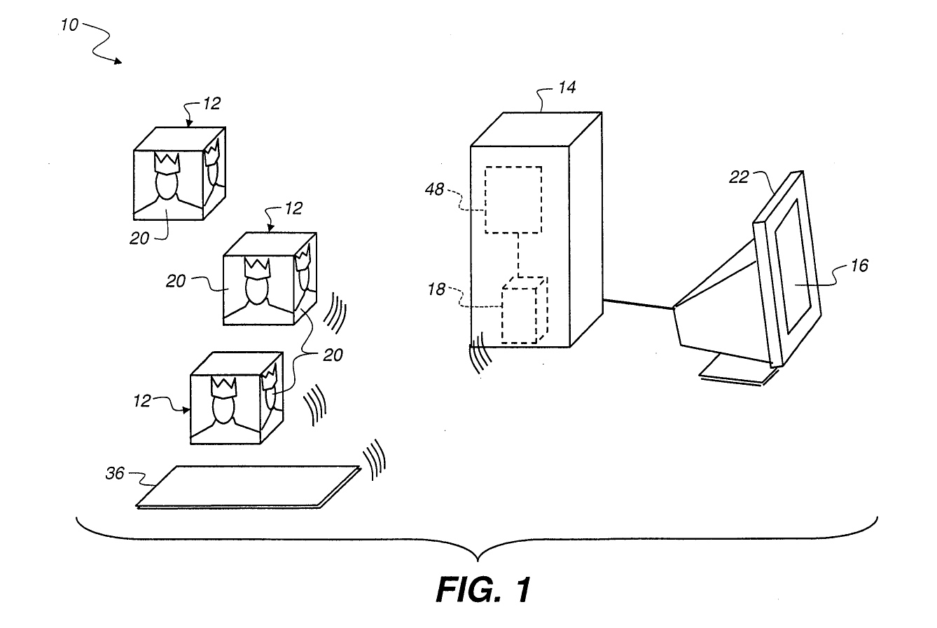

Referring to FIG. 1, there is shown an embodiment with a game apparatus 10 for providing a gaming experience that has movable display units 12 in communication with a host computer 14. Host computer 14 has an operator interface 16 on a display monitor 22 or other suitable display device. The operator interface 16 will also be understood to include the associated circuitry necessary to control the operation of the apparatus. Host computer 14 can be assumed to be part of the operator interface. Host computer 14 has a control logic processor 48, shown in dashed outline, with its supporting memory, storage, and interface circuitry (not shown) and also includes a transceiver 18 that sends and receives signals to and from display units 12. The transceiver 18 can be conventional and the operation of a transceiver by a host computer is well understood in the art. Each display unit 12 has one or more displays 20 that can be actuated to display and change an image according to the game context. Display 20 can have a still or motion picture image formed using image pixels, similar to a display on a color monitor or other image display device that is capable of forming an image according to variable image data. Displays 20 that are on any individual display unit 12 can have different images or the same image. In some embodiments, displays 20 on the same display unit 12 may show the same object from different perspectives, such as displaying side and top views of a subject, for example. An optional playing surface 36 can also be provided as part of game apparatus 10.

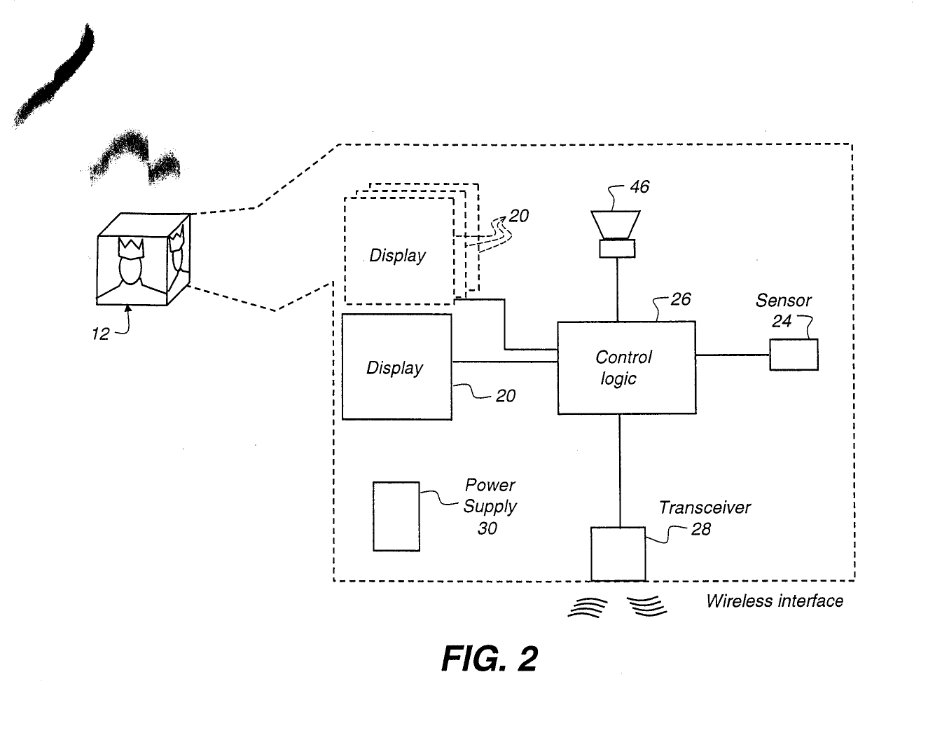

The schematic block diagram of FIG. 2 shows interrelated components of moveable display unit 12 according to one embodiment. One or more displays 20 are controlled from a control logic processor 26 that obtains and stores image data in response to signals obtained through the wireless interface provided by a transceiver 28 that communicates with transceiver 18 on host computer 14 (FIG. 1). A power supply 30, such as a disposable or rechargeable battery or other source, provides the power needed for maintaining communication, logic, sensing, and display functions of display unit 12. An optional speaker 46 can be provided for audio output.

With the embodiment described with reference to FIGS. 1 and 2, display unit 12 is capable of changing its displayed image or images according to wireless signals from host computer 14. By using of one or more sensors 24, display unit 12 is also capable of sensing other display units 12 as well as sensing a marker that may indicate other nearby objects such as other devices or reference locations or sensing position its own positional or rotational orientation. This sensed data is reported to control logic processor 26 and can be transmitted through the wireless interface of transceiver 28 to host computer 14.

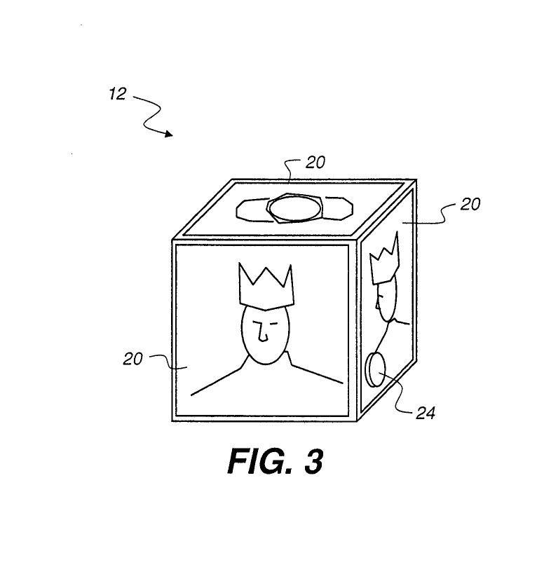

FIG. 3 shows a perspective view of display unit 12 in one embodiment. Here, each display 20 can show a subject, such as a board-game playing piece, from a top, side, or front/back perspective, as appropriate. Sensor 24 is a camera that obtains an image of a nearby marker or other object, or of a person, that can be used for sensing the relative location or orientation of display unit 12.

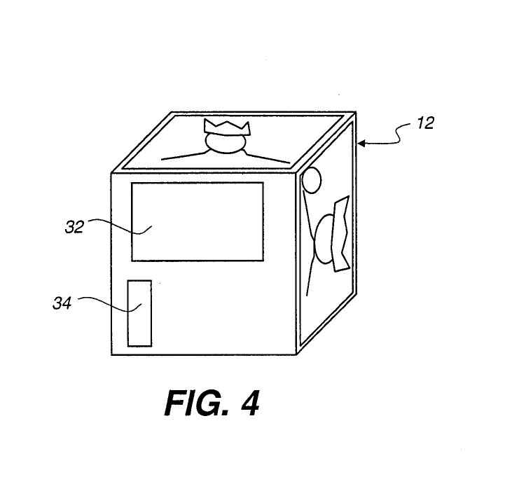

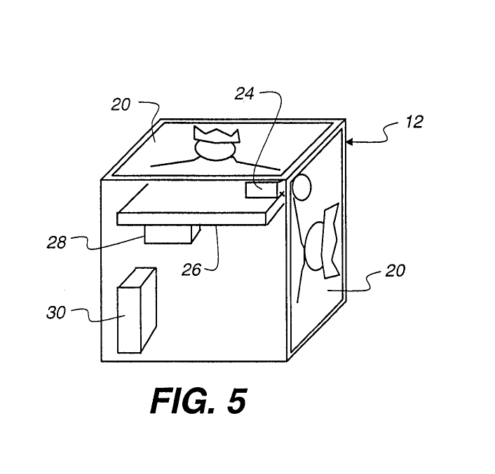

FIGS. 4 and 5 show bottom views of display unit 12 in different embodiments. In FIG. 4, an access panel 32 covers and provides access to internal parts. An optional power connector 34 is provided for recharging an internal battery that provides power supply 30 (FIG. 2). The view of FIG. 5 shows, from a bottom view, with bottom panel removed, the arrangement of internal components of display unit 12 in one embodiment. Power supply 30 is a rechargeable battery in this embodiment. Sensor 24 is a camera. Transceiver 28 can be mounted on the same printed circuit board that also holds control logic processor 26 and related components, as shown. Each display 20 is an Organic Light-Emitting Display (OLED) device that provides a color flat-panel display having good resolution. In other embodiments, display 20 can be a liquid-crystal device (LCD) such as a display commonly used for cellular phones, digital cameras, and other hand-held devices. Display 20 could alternately be an electrophoretic display, such as those used in electronic paper (e-paper) applications. In operation, display 20 may need to be updated at video or near-video rates (such as 25-30 times per second) to provide motion imaging. Alternately, display 20 can be relatively slower in response, maintaining a “still” image for a period of time. Display blanking and other power-conserving techniques, well known in the electronics art, could be used to reduce power overhead when the game is not in use, such as following a suitable time-out period.

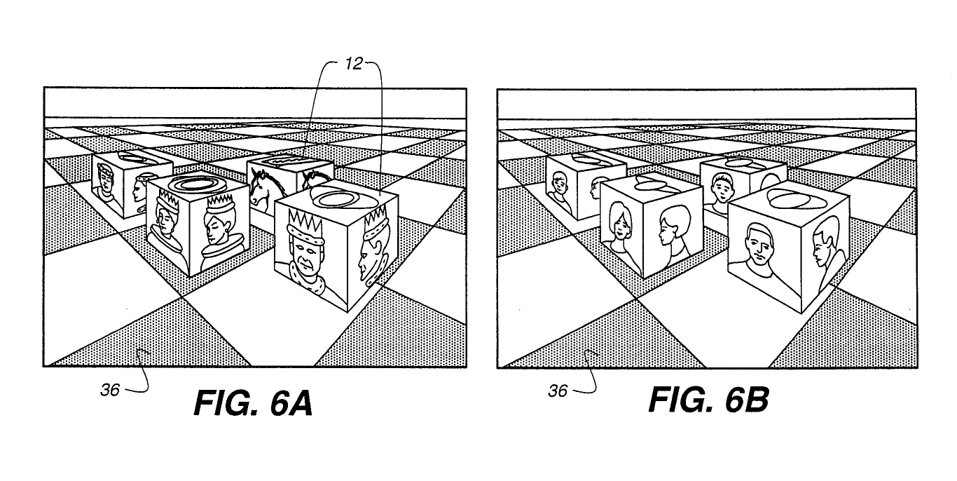

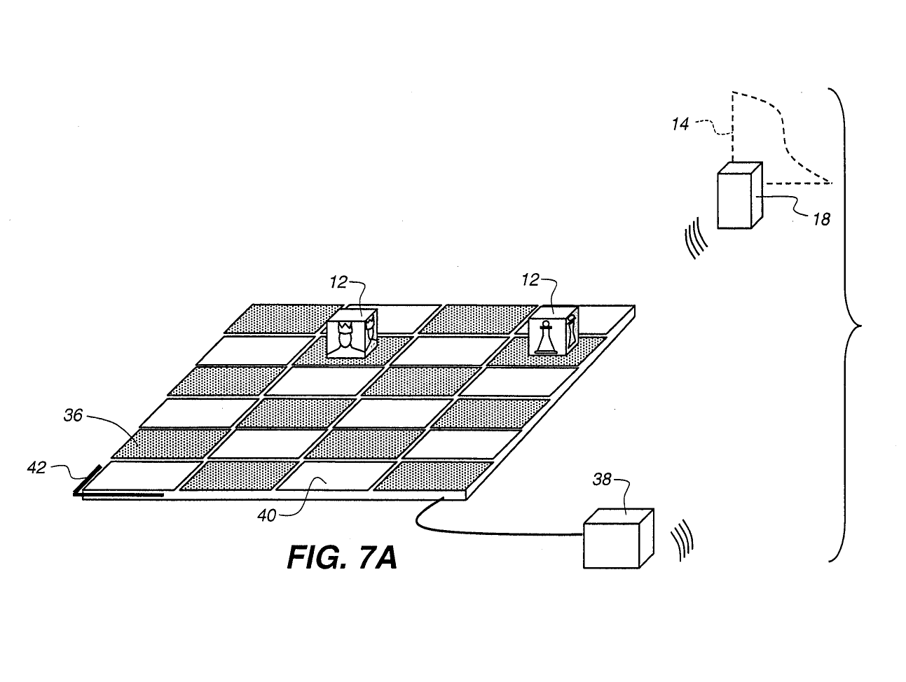

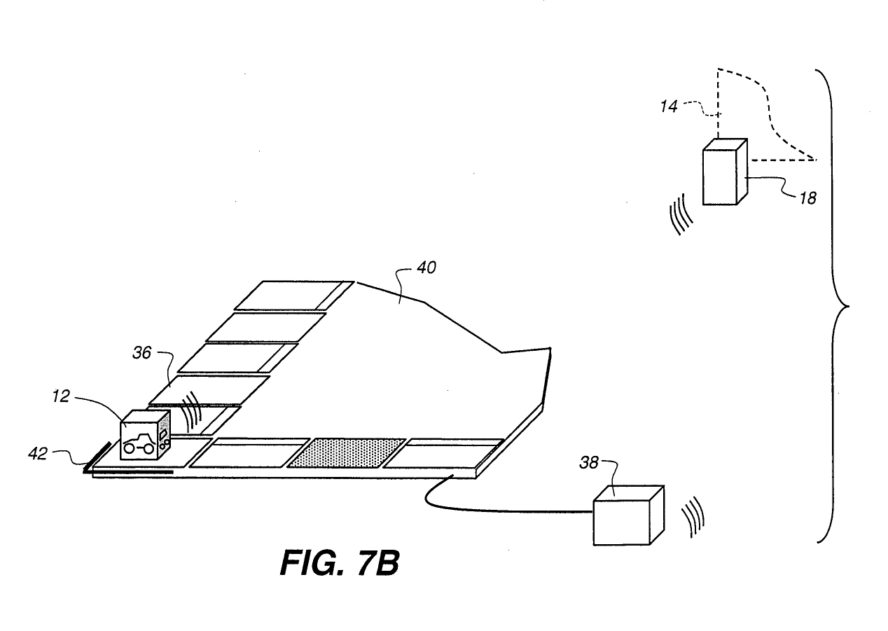

With the various exemplary embodiments described with reference to FIGS. 2-5, display unit 12 can be used for executing any of a number of functions for game play, simulation, or other applications where the position of the display unit can be associated in some way with what it displays. For example, display unit 12 can be used to play a board game, including checkers, chess, and other familiar board games. FIGS. 6A and 6B show a gaming application with different configurations of game pieces that are formed from display units 12 when used on playing surface 36. Playing surface 36 itself can be a fixed-arrangement playing surface, such as the checkerboard surface shown in FIGS. 6A and 6B. Alternately, playing surface 36 itself may be configured for as a type of display unit for display and communication with host computer 14, as shown in the example embodiments of FIGS. 7A and 7B. A wireless interface 38 controls one or more displays 40 that are used to form playing surface 36. In the example portion of game environment of FIG. 7A, playing surface 36 displays a checkerboard arrangement, with display units 12 appropriately displaying chess pieces or other suitable playing pieces. In the alternate game environment of FIG. 7B, playing surface 36 displays as a different type of playing board, with display units 12 configured accordingly.

Playing surface 36 may be relatively passive, but contain some type of grid or pattern of markers or other type of indicia that enable display units 12 to identify themselves and their relative locations. An optional marker 42, shown as a metallized section in FIGS. 7A and 7B, can be provided to serve as a reference point or indicium for locating display units 12 with respect to playing surface 36. Other types of marker can be used, including reference markers that are obtained from analysis of a captured image, for example. Playing surface 36 may alternately be a map or other two-dimensional graphical object. Playing surface 36 may alternately be a sidewall, lying generally in a vertical plane or inclined plane rather than horizontal plane. There may be multiple playing surfaces 36, tiled or interconnected in some way or separately communicating with host computer 14.

Sensor 24 may be any of a number of types of sensor, including a digital camera, a photosensor or photosensor array, a gyroscopic device, an acceleration sensor, a proximity sensor, a radio frequency (RF) transceiver, or an ultrasound sensor, for example. More than one sensor 24 can be provided in a single display unit 12. As indicia, sensor 24 can detect fixed reference points, such as markings on a playing surface such as playing surface 36 or one or more reference locations that emit signals used for position location, including triangularization signals, as described in more detail subsequently. Playing surface 36 may also be provided with a camera or other sensor. This could be used to detect the location of each display unit 12 in the game. The detectable indicium detected by sensor 24 could be any suitable type of reference including a play participant or viewer, depending upon the game or application.

Transceiver 28 can be any of a number of components that are used for wireless communication with a host computer or other processor. For example, the wireless interface of transceiver 28 can utilize Bluetooth transmission, transmission using IEEE 802.11 or other protocol, or other high-speed RF data transmission protocol.

### Behavior

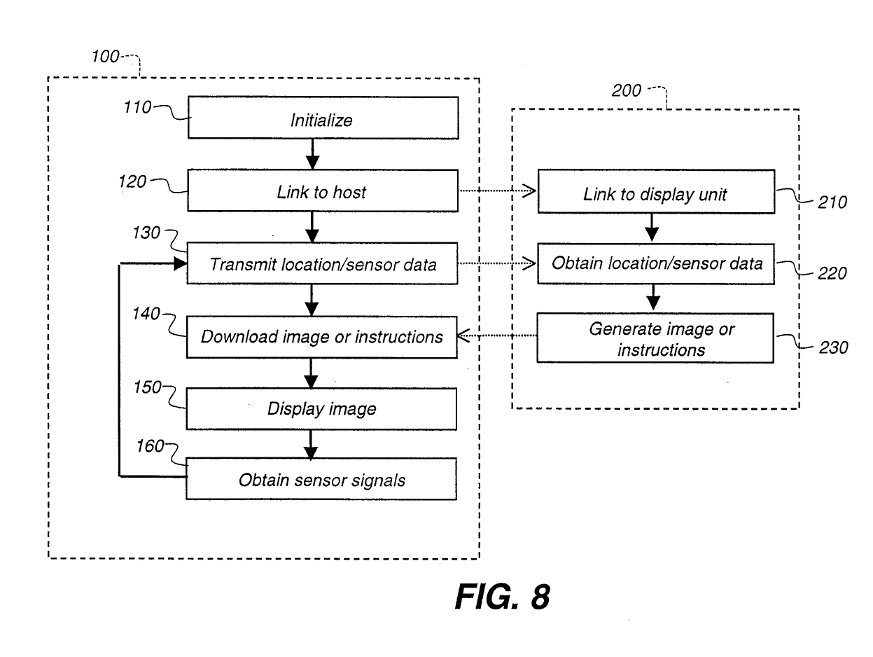

The logic flow diagram of FIG. 8 shows a sequence of process steps executed for communication between display unit 12 and host computer 14 in one embodiment. Outlined steps 100 are executed by control logic processor 26 in display unit 12. Outlined steps 200 are executed at host computer 14.

Referring to FIG. 8, an initialization step 110 is executed upon power-up or upon receipt of a reset or initialization command from host computer 14. Initialization step 110 includes obtaining data from sensor 24 and performing any necessary steps to establish the relative location of the particular display unit 12 and its nearby display units 12 or other components. A link step 120 is then executed, in which display unit 12 attempts to make connection to host computer 14 over the wireless interface provided by its transceiver 28. A corresponding link step 210 is executed at host computer 14, using its transceiver 18. With the communication link between these first and second transceivers 18 and 28 established, a sensor data transmission step 130 is executed. This delivers an initial burst of sensor 24 data to host computer 14 as part of a data acquisition step 220. Processing at host computer 14 then generates an image or instructions in an image or instructions generation step 230. The image data or instructions are then directed to display unit 12, which executes a download step 140. A display image step 150 follows, in which display unit 12 actuates or changes one or more of its displays 20 in response to the image data or instructions received from host computer 14. Display unit 12 also responds to sensor 24 signals in an obtain sensor signals step 160. As shown in FIG. 8, process execution continues with steps 130, 140, 150, and 160 as necessary to respond to changes in the position of display unit 12 or in its surroundings.

It can be appreciated that the example in FIG. 8 admits considerable variation and can be changed in a number of ways within the scope of the present invention. For example, a “wake-up” sequence could be used as part of, or in addition to, initialization step 110, so that a period of inactivity could blank display 20 in order to conserve power. In the same way, sensed motion or other activity could be used to invoke initialization step 110. Various protocols familiar to those skilled in the wireless communication arts could be employed for link steps 120 and 210 and for the back-and-forth transmission between transceivers on display unit 12 and its host computer 14.

The image or instructions generated and transmitted in step 230 could be one or more complete images for the one or more displays 20 on display unit 12. Alternately, the images themselves could be stored in memory that is in communication with control logic processor 26 (FIG. 2), so that host computer 14 merely sends an instruction that specifies which stored image to display. For example, for an automated checkers game, there may only be four displays needed. It can be enough for host computer 14 to instruct display unit 12 to display a red or black playing-piece, or a red or black “king”, for which only a small amount of display data can be stored directly in memory on control logic processor 26. Such a display would not need to change except when there is a transition to “king” or when a piece is removed from play, for example. On the other hand, a more interactive or complex game may even require animation, so that image or instructions generation step 230 is ongoing. For example, an interactive chess game may use different player faces or caricatures on display unit 12, whose expressions change depending on what other display unit 12 playing pieces portray or their relative location or depending on player actions, such as an attempt by the player to pick up and move or otherwise re-orient the display unit 12 playing piece. Optionally, audio output of some type can be provided from display unit 12 in response to the positions of adjacent movable units or of nearby objects.

Although display unit 12 has been described primarily for game use with respect to game apparatus 10 and simulation, it can be appreciated that the uses of display unit 12 extend beyond gaming to application in many other areas. For example, display unit 12 can be used in various applications where the combination of spatial position and display is helpful for visualization or problem-solving. These can include applications as varied as crime-scene simulation, strategic mapping for military exercises, interior design, architecture, and community planning, for example. Display unit 12 and its associated devices can be used for training purposes, particularly where it can be helpful to portray levels of structure, such as within a living being, mechanical or structural apparatus, geographical structure, or organization. This can be particularly true where multiple display units 12 are used for graphical representation.

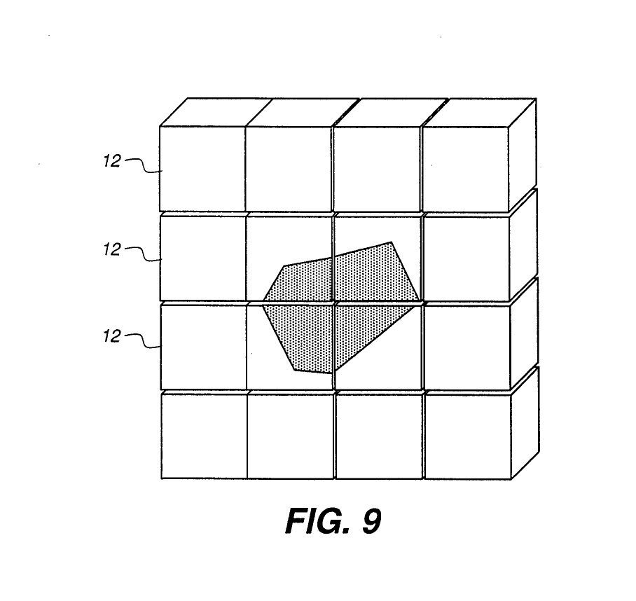

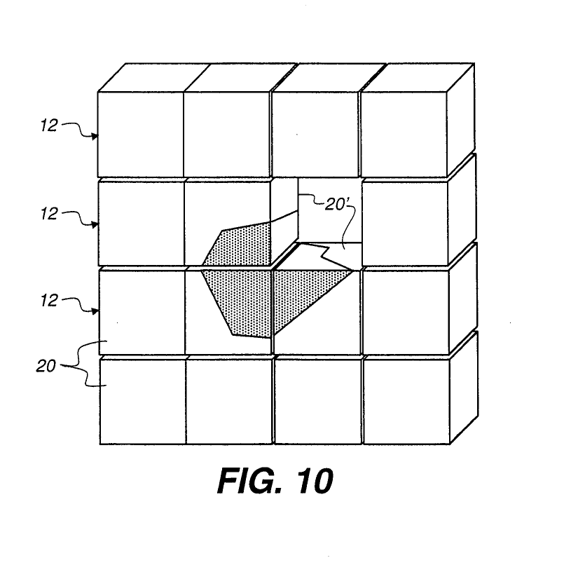

The examples of FIGS. 9-12 show a number of features that become available when using multiple display units 12. In the example of FIG. 9, multiple display units 12 are aligned and each display unit 12 shows a segment of a larger image. That is, tiling multiple display units 12 forms a larger image. Removal of one of display units 12 as shown in FIG. 10 allows the orthogonally disposed displays 20′ to show portions of the displayed item from a different perspective, such as to show depth.

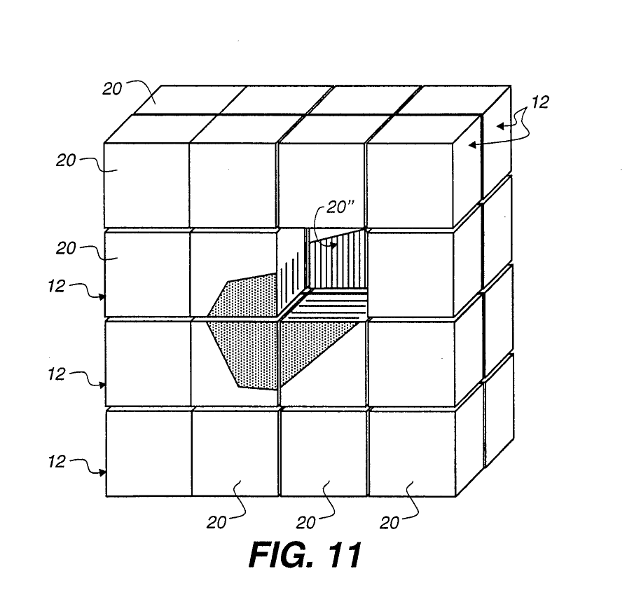

FIG. 11 shows a further extension of the concept shown in FIG. 9, in which display units 12 are layered. With this type of arrangement, removal of a display unit 12 that displays an outer layer of an object allows a view of an inner layer in a display 20″, as shown.

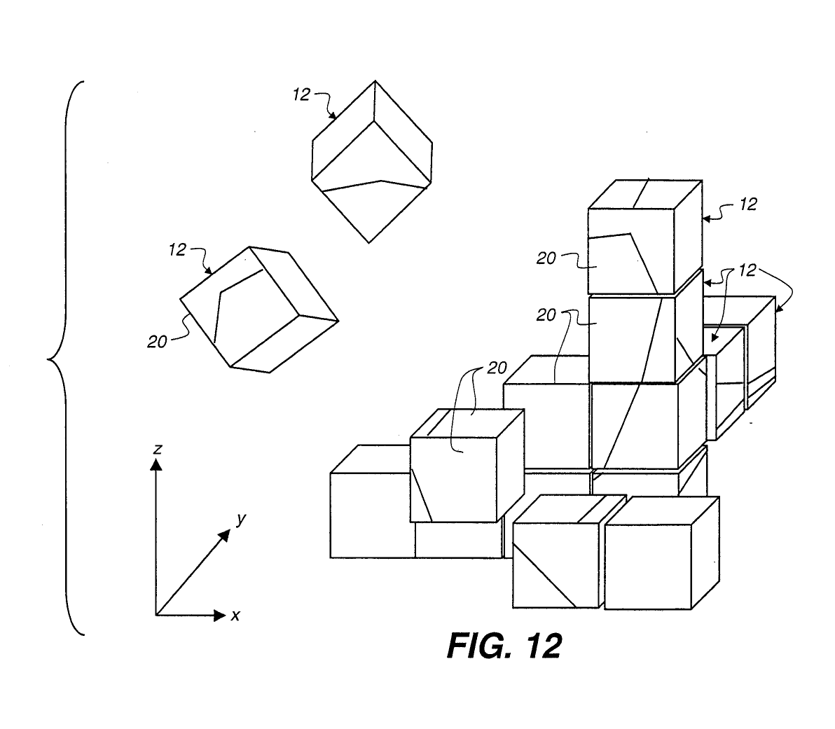

FIG. 12 shows how the concepts of depth, perspective, and spatial orientation can be combined using an arrangement with multiple display units 12. As just one example, display units 12 could be used to display parts of the human body, with the particular image currently displayed at any display 20, varying according to the orientation and position in space of its corresponding display unit 12. By moving a display unit 12 and observing corresponding changes in display 20, a student could trace the path of a bone or tissue structure as if “inside” the body, for example. Other examples and applications for display of cross sections within a volume can be envisioned, allowing a viewer to manipulate the position of display unit 12 within a defined volume in order to display features in cross-sectional aspect.

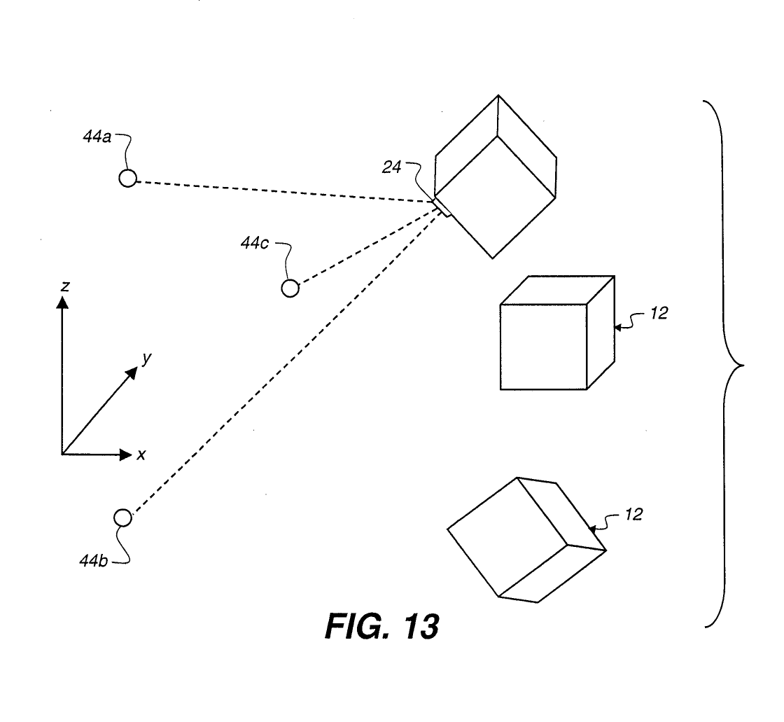

In a number of embodiments, display unit 12 of the present invention uses sensor 24 to determine its own spatial position. FIG. 13 shows how display unit 12 can determine its reference position in three-dimensional space using triangularization. In this embodiment, the pattern formed by three references 44a, 44b, and 44c is sensed by sensor 24. Analysis of the pattern, either at display unit 12 or at the host processor, is then used to identify the spatial position and orientation of display unit 12 with regard to these references 44a, 44b, and 44c. References 44a, 44b, and 44c can be, for example, some type of emitter for emitting visible light. Sensor 24 can then sense a light pattern as an indicator of its position, either directly or by comparison with a previously sensed light pattern. More generally, sensor 24 can be configured to detect other emitted signals, such as ultrasound, infrared light, or other electromagnetic signal that may be continuous or pulsed or provided in response to a stimulus such as movement of display unit 12 or of objects or people in its environment. More than three references 44a, 44b, and 44c may be provided as necessary, depending on the type of signal that is used for positional sensing. Alternately, one or more of references 44a, 44b, and 44c may itself be a passive device or a sensor for obtaining or redirecting a signal that is emitted from display unit 12. A combination of sensors 24 could also be used for detecting translational and rotational movement, such as to detect or correct for tilt or rotation.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, display units 12 can have one or more displays 20 and could be formed as cubes, as shown in the accompanying FIGS., or formed in some other shape. Each outside surface of display unit 12 could have a display, so that the display unit 12 could be placed in and viewed from any position. Displayed images on display unit 12 could be monochrome or color, still or video (animated) and could be used to control position of a camera or other device that captures the image that is displayed. Real-time imaging, in which the image displayed on display unit 12 is obtained from a remote still or video camera, can also be provided.

Display unit 12 could be used in numerous applications, wherever the capability for display on a manipulable unit can be advantageous. For example, display unit 12 could also be used as a pointing device, such as for a computer mouse or similar cursor control device. In various applications, displays 20 could be used to display avatars. Used particularly in on-line gaming, Internet forums, and virtual reality applications, an avatar represents the user, such as in the form of a two- or three-dimensional model. The avatar may have the user's own appearance or may have some selected or assigned appearance, depending on the application. In a virtual reality or virtual world application, one or more avatars can be downloaded to displays 20 to provide a suitable two- or three-dimensional rendition of a character or person. Display unit 12 configured in this way could then be used similarly to a mouse or other cursor manipulation device. The display unit, with the avatar displayed, could be oriented or moved to simulate teleporting, turning, or walking, for example. The online rendition would respond appropriately. Such an embodiment would lend itself to imaginative play applications, including applications for children. On-line advertising and purchasing applications could also use this type of feature.

Thus, what is provided is an apparatus and method for portable display devices having sensing and communication capabilities for interaction within a mixed reality environment.

Those skilled in the art will recognize that many variations may be made to the description of the present invention without significantly deviating from the scope of the present invention.

### PARTS LIST

10 Game apparatus
12 Display monitor
14 Host computer
16 Operator interface
18 Transceiver
20 Display
20′ Orthogonally disposed display
20″ View of inner layer display
22 Monitor
24 Sensor
26 Control logic processor
28 Transceiver
30 Power supply
32 Panel
34 Power connector
36 Playing surface
38 Wireless interface
40 Display
42 Marker
44a Reference
44b Reference
44c Reference
46. Speaker
48. Control logic processor
100. Step
110 Initialization step
120 Link step
130 Transmission step
140 Download step
150 Display image step
160 Obtain sensor signals step
200 Step
210 Link step
220 Data acquisition step
230 Image or instructions generation step

1. An apparatus for providing a gaming experience comprising:
a. a plurality of moveable display units each of which includes one or more displays that when actuated change a visual image associated with the display,
b. an operator interface including a computer and a first transceiver for sending and receiving signals from the moveable display units,
c. each moveable display unit including a second transceiver and an associated sensor for detecting a marker indicating the position of the display unit and for providing a signal to the first transceiver which communicates with the computer; and
d. the computer responds to the signal to cause the first transceiver to send a signal to the second transceiver on the moveable display unit to actuate a change in the visual image associated with such moveable display unit.

2. The apparatus of claim 1 wherein a display unit detects the presence of another display unit and changes the visual image associated with the display.

3. The apparatus of claim 1 wherein a display unit detects the presence of an object other than a display unit and changes the visual image associated with the display.

4. The apparatus according to claim 1 wherein an audio system in each moveable display unit for producing sounds, which are selected by the computer in response to the positions of other movable units.

5. Apparatus for providing a gaming experience comprising:
a. a game board including a surface and having detectable indicia indicating the position on the surface;
b. a plurality of moveable display units disposed on the surface each of which includes one or more displays that when actuated change a visual image associated with the display;
c. an operator interface including a computer and a first transceiver for sending and receiving signals from the moveable display units;
d. each moveable display unit including a second transceiver and an associated sensor for detecting a detectable indicium indicating the position of the display unit and for providing a signal to the first transceiver which communicates with the computer and; and
e. the computer responds to the signal to cause the first transceiver to send a signal to the second transceiver on the moveable display unit to actuate a change in the visual image associated with such moveable display unit.

6. The apparatus of claim 5 wherein the surface includes detectable indicia, sensing means for detecting the indicia to determine the position of its corresponding movable display unit on the surface.

7. The apparatus of claim 5 wherein a display unit detects the presence of another display unit and changes the visual image associated with the display.

8. The apparatus of claim 5 wherein a display unit detects the presence of an object other than a display unit and changes the visual image associated with the display.

9. The apparatus of claim 5 wherein an audio system in each moveable display unit for producing sounds, which are selected by the computer in response to the positions of other movable units.

10. The apparatus of claim 5 wherein the surface includes one or more displays.

11. A method for providing a gaming experience comprising
a. displaying a first image of an object on a portable display unit according to a first spatial location;
b. sensing information on movement of the portable display unit from the first spatial location to a second spatial location; and
c. displaying a second image of the object on the portable display unit in response to movement of the portable display unit from the first to the second spatial location;

12. The method of claim 11 wherein the information on movement comprises information on translational movement.

13. The method of claim 11 wherein the information on movement comprises information on rotational movement.

14. A method for providing different images of a given object comprising:
a. displaying a first image of a portion of an object on a portable display unit according to a first spatial location;
b. a user manually changing the position of the portable display unit from the first spatial location to a second spatial location;
c. sensing information on movement of the portable display unit from the first spatial location to the second spatial location and displaying a second image of a different portion of the object from the second position; and
d. displaying a second image of the object on the portable display unit in response to movement of the portable display unit from the first to the second spatial location.

15. The method of claim 14 wherein the object is a human being and the visual displays in the first and second positions are cross-sections from within the human being.
